(19) United States
(12) Patent Application Publication
(10) Pub. No.: US 2024/0286596 A1
(43) Pub. Date: Aug. 29, 2024

(54) BRAKING CONTROL DEVICE FOR VEHICLE

(71) Applicant: ADVICS CO., LTD., Kariya-shi, Aichi-ken (JP)

(72) Inventor: Ryosuke ENDO, Kariya-shi, Aichi-ken (JP)

(73) Assignee: ADVICS CO., LTD, Kariya-shi, Aichi-ken (JP)

(21) Appl. No.: 18/571,290

(22) PCT Filed: Jul. 27, 2022
(86) PCT No.: PCT/JP2022/028953

§ 371 Date: Dec. 18, 2023

(30) Foreign Application Priority Data
Jul. 27, 2021 (JP) 2021-122164

(51) Int. Cl. B60T 17/22; B60T 13/14; B60T 13/66

(52) U.S. Cl. CPC B60T 17/22; B60T 13/148; B60T 13/662

(57) ABSTRACT

A braking control device includes: a master cylinder having a master chamber defined by a master piston; and a first pressure regulation unit having a servo chamber located on an opposite side of the master chamber and supplying a servo pressure to the servo chamber to generate a master pressure in the master chamber. The first pressure regulation unit acquires the master pressure and servo pressure and determines bottoming out of the master piston based on a comparison between the master and servo pressures. The first pressure regulation unit may make the comparison based on pressure-receiving area of the servo chamber and a pressure-receiving area of the master chamber. If the servo chamber pressure-receiving area is equal to the master chamber pressure-receiving area, the first pressure regulation unit determines bottoming out occurs when a difference between the servo pressure and the master pressure equals or exceeds a predetermined pressure.

### TECHNICAL FIELD

The present disclosure relates to a braking control device for a vehicle.

### BACKGROUND ART

It is described in PTL 1 that, in a hydraulic brake system that includes a cylinder device having a front chamber in front of a pressurization piston and a rear chamber behind the piston, presence or absence of fluid leakage in a brake structure is detected on the basis of a hydraulic pressure in the rear chamber. More specifically, it is determined that the pressurization piston has bottomed out due to leakage of a hydraulic fluid in the front chamber in the case where a value ΔP, which is acquired by subtracting an actual rear hydraulic pressure from a target rear hydraulic pressure, remains to be higher than a first abnormality determination threshold value ΔPth for a first abnormality determination time T1 or longer, where an actual rear hydraulic pressure Ps is then increased with a set gradient or greater, and where the subtraction value ΔP becomes lower than a return determination threshold value op.

It is described in PTL 2 to determine whether a state of each of master pistons 12c, 12d is a bottoming state on the basis of a reaction hydraulic pressure that is detected by a reaction hydraulic pressure detection unit 25b and a master hydraulic pressure that is detected by a master hydraulic pressure detection unit Y. In detail, in PTL 2, in the case where a stroke is shorter than a predetermined value (for example, a value corresponding to a stroke with which a piston 13a2 of a stroke simulator 13a bottoms out), a bottoming determination is made on the basis of an increase amount of the stroke per unit time and an increase amount of the master hydraulic pressure per unit time. On the other hand, in the case where the stroke is equal to or longer than the predetermined value, the bottoming determination is made on the basis of an increase amount of a reaction hydraulic pressure per unit time and the increase amount of the master hydraulic pressure per unit time.

In PTL 1, the presence or the absence of the fluid leakage in the brake structure is detected on the basis of a difference between a control target (that is, the target rear hydraulic pressure) and a control result (that is, the actual rear hydraulic pressure). In PTL 2, since the stroke and the reaction hydraulic pressure correspond to the input at the brake pedal, state amounts thereof are used to determine the control target in hydraulic pressure control. Meanwhile, the master hydraulic pressure is a result of pressure regulation control. Thus, similar to PTL 1, occurrence of the bottoming out (that is, the bottoming state) is also determined in PTL 2 on the basis of a relationship between the control target and the control result.

By the way, a certain duration of time is required for a reliable determination based on an interrelationship between the control target and the control result. More specifically, control is vulnerable to an error, a time delay, and the like. Thus, in order to reliably identify that the bottoming out is a cause of the difference between the control target and the control result, it is necessary to wait until a determination threshold value, which cannot be generated when the bottoming out does not occur, is reached, or additional calculation processing is required. For example, in PTL 1, the bottoming state is determined in the case where a value, which is acquired by subtracting the actual rear force from an estimated rear force, remains to be equal to or larger than the first abnormality determination threshold value for the first abnormality determination time or longer, and thereafter becomes equal to or smaller than a first return determination threshold value, which is smaller than the first abnormality determination threshold value. In PTL 2, a gradient ratio of the increase amount of the master hydraulic pressure per unit time to the increase amount of the reaction hydraulic pressure per unit time, is calculated. Then, in the case where this is equal to or lower than a predetermined ratio, the bottoming state is determined. Thus, it is desired to be able to determine the bottoming state promptly and reliably with simple processing.

### CITATION LIST

### Patent Literature

PTL 1: WO2012/172702
PTL 2: JP2018-058465A

### SUMMARY

### Technical Problem

An object of the disclosure is to provide a braking control device for a vehicle capable of determining bottoming out of a master piston promptly and reliably.

### Solution to Problem

A braking control device SC according to the disclosure here includes: a “master cylinder (CM) that has a master chamber (Rm) divided by a master piston (NP, NS)”; and “a first pressure regulation unit (YA) that has a servo chamber (Ru) located on an opposite side of the master piston (NP, NS) from the master chamber (Rm) and supplies a servo pressure (Pu) to the servo chamber (Ru), so as to generate a master pressure (Pm) in the master chamber (Rm)”. The first pressure regulation unit (YA) acquires the master pressure (Pm) and the servo pressure (Pu), and determines bottoming out of the master piston (NP, NS) on the basis of a comparison between the master pressure (Pm) and the servo pressure (Pu). For example, the first pressure regulation unit (YA) makes the comparison on the basis of a pressure-receiving area (ru) of the servo chamber (Ru) and a pressure-receiving area (rm) of the master chamber (Rm). In a configuration that the pressure-receiving area (ru) of the servo chamber (Ru) is equal to the pressure-receiving area (rm) of the master chamber (Rm), the first pressure regulation unit (YA) determines occurrence of the bottoming out in the case where a difference (hP=Pu−Pm) between the servo pressure (Pu) and the master pressure (Pm) is equal to or greater than a predetermined pressure (px).

In the braking control device SC, when master bottoming does not occur, the servo pressure Pu and the master pressure Pm are in a predetermined relationship (for example, when “ru=rm” is set, the servo pressure Pu matches the master pressure Pm). However, this predetermined relationship is not established when the master bottoming occurs. Based on this, a bottoming state of the master piston is determined on the basis of the comparison between the servo pressure Pu and the master pressure Pm. According to the above configuration, a bottoming determination is not made by a comparison between a control target and a control result. Thus, a time required to avoid an error, a delay, and the like of pressure regulation control is not required. Therefore, the prompt and reliable bottoming determination can be made by simple calculation processing.

### BRIEF DESCRIPTION OF DRAWINGS

FIG. 1 is a schematic view for illustrating an overall vehicle JV to which a braking control device SC is mounted.

FIG. 2 is a schematic view for illustrating a first configuration example of a first pressure regulation unit YA.

FIG. 3 is a schematic view for illustrating a configuration example of a second pressure regulation unit YB.

FIG. 4 is a flowchart for illustrating pressure regulation control.

FIG. 5 is a flowchart for illustrating bottoming processing.

FIG. 6 includes time-series graphs for illustrating operation in a bottoming determination.

FIG. 7 includes time-series graphs for illustrating operation in compensation control that is based on a bottoming determination result.

FIG. 8 is a schematic view for illustrating a second configuration example of the first pressure regulation unit YA.

### DESCRIPTION OF EMBODIMENTS

Hereinafter, a description will be made on a embodiment of a braking control device SC for a vehicle with reference to the drawings.

### <Reference Signs of Components, Etc.>

In the following description, components including members, signals, or values denoted by the same reference signs, such as “CW”, will have the same functions. Characters “f” and “r” added to ends of various reference signs for wheels are inclusive reference signs indicating whether the components are related to a front wheel or a rear wheel. More specifically, “f” indicates the “component related to the front wheel” while “r” indicates the “component related to the rear wheel”. Examples are “a front wheel cylinder CWf, a rear wheel cylinder CWr” for wheel cylinders CW. Furthermore, the additional characters “f”, “r” may be omitted. When these are omitted, the reference sign represents a collective term thereof.

In a communication path HS, a portion away from the wheel cylinder CW will be referred to as an “upper portion” while a portion close thereto will be referred to as a “lower portion”. An example the description is that “a brake fluid BF is suctioned from an upper portion of a pressure regulator UB and is discharged into a lower portion of the pressure regulator UB” in regard to movement of the brake fluid BF caused by a fluid pump QB. First and second pressure regulation units YA, YB will also be referred to as “upper and lower pressure regulation units YA, YB”. The first and second pressure regulation units YA, YB are each configured as a pair of an actuator (a fluid unit) and a controller. More specifically, the first pressure regulation unit YA is configured as a combination of a first fluid unit HA and a first controller ECA, and the second pressure regulation unit YB is configured as a combination of a second fluid unit HB and a second controller ECB. Here, the first and second fluid units HA, HB will also be referred to as “upper and lower fluid units HA, HB”. Similarly, the first and second controllers ECA, ECB will also be referred to as “upper and lower controllers ECA, ECB”. Furthermore, regulation (an increase or the like) of a wheel pressure Pw by the first pressure regulation unit YA will be referred to as “upper pressure regulation” while the regulation (the increase or the like) of the wheel pressure Pw by the second pressure regulation unit YB will be referred to as “lower pressure regulation”.

<Vehicle JV Mounted with Braking Control Device SC>

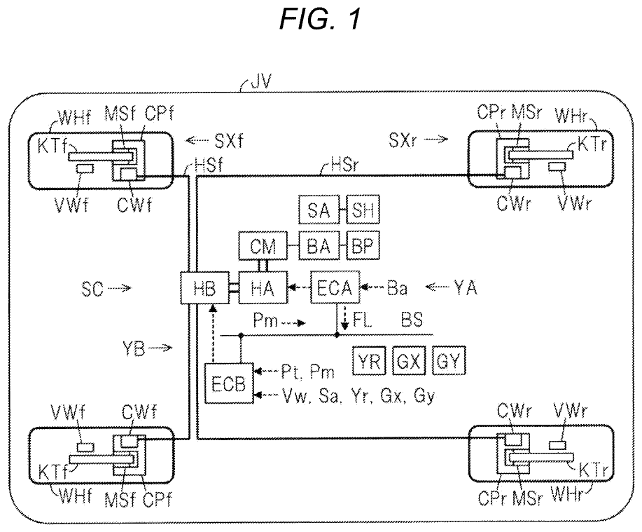

A description will be made on an overall configuration of a vehicle JV, to which the braking control device SC according to the disclosure is mounted, with reference to the schematic view in FIG. 1.

The vehicle JV includes a braking operation member BP, a steering operation member SH, and various sensors (BA and the like). The braking operation member (for example, a brake pedal) BP is a member that is operated by a driver to decelerate the vehicle JV. The steering operation member (for example, a steering wheel) SH is a member that is operated by the driver to turn the vehicle JV.

The vehicle JV includes the various sensors listed below.
A braking operation amount sensor BA that detects an operation amount (a braking operation amount) Ba of the braking operation member BP, and a steering operation amount sensor SA that detects an operation amount (a steering operation amount such as a steering angle) Sa of the steering operation member SH
A wheel speed sensor VW that detects a rotational speed (wheel speed) Vw of a wheel WH
For the vehicle JV (in particular, a vehicle body), a yaw rate sensor YR that detects a yaw rate Yr, a front-rear acceleration sensor GX that detects front-rear acceleration Gx, and a lateral acceleration sensor GY that detects lateral acceleration Gy

The vehicle JV includes a braking device SX and the braking control device SC. A so-called front-rear type (also referred to as a “type II”) of the braking control device SC is adopted as two braking systems.

The braking device SX (=SXf, SXr) is configured to include a rotary member (for example, a brake disc) KT and a brake caliper CP. The rotary member KT is fixed to the vehicle wheel WH, and the brake caliper CP is provided to sandwich the rotary member KT. The brake caliper CP is provided with the wheel cylinder CW. The wheel cylinder CW is supplied with the pressurized brake fluid BF from the braking control device SC. Here, a hydraulic pressure in the wheel cylinder CW will be referred to as the “wheel pressure Pw”. In the braking device SX, a friction member (for example, a brake pad) MS is pressed against the rotary member KT by the wheel pressure Pw. Since the rotary member KT and the wheel WH are fixed to rotate together, braking torque Tb (resulting in a braking force Fb) is generated on the wheel WH by a friction force that is generated at this time.

The braking control device SC regulates the actual wheel pressure Pw according to the operation amount Ba of the braking operation member BP. More specifically, the brake fluid BF, which has been pressurized by the braking control device SC, is supplied to the braking device SX (in particular, the wheel cylinders CW) via front-wheel and rear-wheel communication paths HSf, HSr. The braking control device SC is configured to include a master cylinder CM and the first and second pressure regulation units YA, YB. The first pressure regulation unit YA includes the first fluid unit HA and the first controller ECA. The second pressure regulation unit YB includes the second fluid unit HB and the second controller ECB. The first controller ECA and the second controller ECB are connected via a communication bus BS so as to be able to share signals (detection values, calculation values, and the like).

The master cylinder CM, the first and second pressure regulation units YA, YB (in particular, the first and second fluid units HA, HB), the wheel cylinders CW, and the like are connected by the communication path HS, an input path HN, a pressure reduction path HG, a recirculation path HK, HL, a servo path HU, and the like. These are fluid paths, through each of which the brake fluid BF moves. Fluid pipes, fluid paths in the fluid units HA, HB, hoses, and the like correspond to the fluid paths (HS and the like).

The vehicle JV is decelerated by the braking control device SC when the wheel pressure Pw is generated according to the braking operation amount Ba. That is, the braking control device SC is used as a service brake (also referred to as a “main brake”). Furthermore, the braking control device SC executes vehicle stability control (so-called ESC) for regulating the hydraulic pressures Pw in the wheel cylinders CW independently and separately, so as to improve stability of the vehicle JV. Moreover, the braking control device SC executes braking force distribution control (so-called EBD control) for limiting the hydraulic pressure Pwr (the rear wheel pressure) in the rear wheel cylinder CWr, so as to ensure the stability of the vehicle JV during braking.

A function of the service brake by the braking control device SC is accomplished by the first pressure regulation unit YA and the second pressure regulation unit YB. In the service brake, the braking operation amount Ba is input to the first controller ECA, and a required pressure Ps is calculated. In the first controller ECA, a target pressure Pt related to the first pressure regulation unit YA and a target differential pressure Qt related to the second pressure regulation unit YB (in particular, the pressure regulator UB) are calculated on the basis of the required pressure Ps. Then, the first fluid unit HA is controlled by the first controller ECA on the basis of the target pressure Pt. The target differential pressure Qt is transmitted to the second controller ECB via the communication bus BS, and the second fluid unit HB is controlled by the second controller ECB on the basis of the target differential pressure Qt.

Meanwhile, functions (the vehicle stability control, the braking force distribution control, and the like) of a control brake by the braking control device are accomplished by the second pressure regulation unit YB. The wheel speed Vw, the steering operation amount (the steering angle) Sa, a hydraulic pressure Pm in the master cylinder CM, the yaw rate Yr, the front-rear acceleration Gx, and the lateral acceleration Gy are input to the second controller ECB. Then, the second fluid unit HB is controlled by the second controller ECB to improve directional stability of the vehicle JV.

The hydraulic pressure Pm in the master cylinder CM is transmitted to the first controller ECA via the communication bus BS so as to determine bottoming states of first and second master pistons NP, NS. The first controller ECA identifies the bottoming states of the master pistons inserted in the master cylinder CM. Then, as a determination result of the bottoming state, a determination flag FL is transmitted to the second controller ECB via the communication bus BS. Details of the above processing will be described below.

### <First Configuration Example of First Pressure Regulation Unit YA>

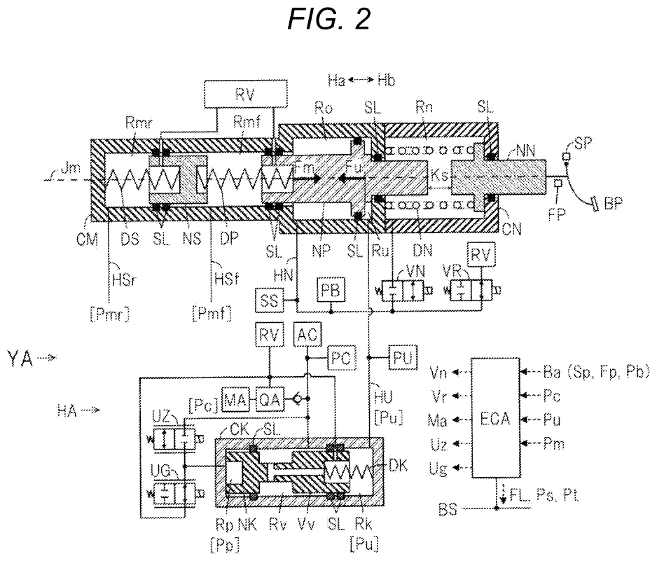

A description will be made on a first configuration example of the first pressure regulation unit (the upper pressure regulation unit) YA with reference to a schematic view in FIG. 2. The first pressure regulation unit YA is a pressurization source for increasing the hydraulic pressures (the wheel pressures) Pw in the four wheel cylinders CW. In the example, the first pressure regulation unit YA is integrated with the master cylinder CM. In addition, the two braking systems of the front-rear type are adopted. The first pressure regulation unit YA is configured to include the first fluid unit HA and the first controller ECA controlling the first fluid unit HA.

The first fluid unit HA is integrated with a master reservoir RV, the master cylinder CM, the first and second master pistons NP, NS, and first and second master springs DP, DS. The first fluid unit HA includes an input cylinder CN, an input piston NN, an input spring DN, an input valve VN, a relief valve VR, a stroke simulator SS, and a simulator pressure sensor PB.

The master reservoir (also referred to as an “atmospheric pressure reservoir”) RV is a tank for a hydraulic fluid and stores the brake fluid BF therein. The master reservoir RV is connected to the master cylinder CM (in particular, front-wheel and rear-wheel master chambers Rmf, Rmr).

The master cylinder CM is a bottomed cylinder member. The first and second master pistons NP, NS are inserted in the master cylinder CM. The inside of the master cylinder CM is sealed by sealing members SL, and is divided into the front-wheel and rear-wheel master chambers Rmf, Rmr. In detail, the front-wheel master chamber Rmf is defined by an inner circumferential surface of the master cylinder CM, an end surface of the first master piston NP, and an end surface on one side of the second master piston NS. The rear-wheel master chamber Rmr is defined by the inner circumferential surface of the master cylinder CM, a bottom surface of the master cylinder CM, and an end surface on the other side of the second master piston NS. The master cylinder CM is of a so-called tandem type. Here, a hydraulic pressure Pmf in the front-wheel master chamber Rmf will be referred to as a “front-wheel master pressure”, and a hydraulic pressure Pmr in the rear-wheel master chamber Rmr will be referred to as a “rear-wheel master pressure”. Accordingly, as a collective term, the hydraulic pressure Pm in the master chamber Rm will be referred to as a “master pressure”.

The first and second master springs DP, DS are respectively provided in the front-wheel and rear-wheel master chambers Rmf, Rmr. By the first and second master springs DP, DS, the first and second master pistons NP, NS are pressed in a withdrawal direction Hb (a direction in which a volume of the master chamber Rm is increased, and an opposite direction from an advancing direction Ha). The front-wheel and rear-wheel master chambers Rmf, Rmr (=Rm) are eventually connected to the front and rear wheel cylinders CWf, CWr (=CW), respectively, via the front-wheel and rear-wheel communication paths HSf, HSr (=HS) and the second pressure regulation unit YB (in particular, the second fluid unit HB).

The first master piston NP is provided with a collar (a flange). By this collar, the inside of the master cylinder CM is further divided into a servo chamber Ru and a rear chamber Ro for the first pressure regulation unit YA. The servo chamber Ru in the first pressure regulation unit YA is arranged to oppose the front-wheel master chamber Rmf with the first master piston NP in between such that the hydraulic pressures Pmf, Pmr can be generated in the front-wheel and rear-wheel master chambers Rmf, Rmr, respectively. The rear chamber Ro in the first pressure regulation unit YA is held between the front-wheel master chamber Rmf and the servo chamber Ru and is arranged between those, so as to absorb the brake fluid BF discharged from an input chamber Rn. Similar to the above, each of the servo chamber Ru and the rear chamber Ro is also sealed by the sealing members SL.

The input cylinder CN is fixed to the master cylinder CM. The input piston NN is inserted in the input cylinder CN, the inside of the input cylinder CN is sealed by the sealing member SL, and the input chamber Rn is thereby formed. The input piston NN is mechanically connected to the braking operation member BP via a clevis (a U-shaped link). The input piston NN is provided with a collar (a flange). The input spring DN is provided between this collar and an attachment surface of the input cylinder CN to the master cylinder CM. The input piston NN is pressed in the withdrawal direction Hb by the input spring DN.

The input chamber Rn, the servo chamber Ru, the rear chamber Ro, and the front-wheel and rear-wheel master chambers Rmf, Rmr are hydraulic chambers (hydraulic pressure chambers). The “hydraulic chamber” is filled with the brake fluid BF and is sealed by the sealing member SL. A volume of each of the hydraulic chambers is changed by movement of the input piston NN and the first and second master pistons NP, NS. In arrangement of the hydraulic chambers, the input chamber Rn, the servo chamber Ru, the rear chamber Ro, the front-wheel master chamber Rmf, and the rear-wheel master chamber Rmr are sequentially aligned along a center axis Jm of the master cylinder CM, in an order from the side near the braking operation member BP.

The input chamber Rn and the rear chamber Ro are connected to each other via the input path HN. The input valve VN is then provided to the input path HN. At a position between the rear chamber Ro and the input valve VN, the input path HN is connected to the master reservoir RV via the relief valve VR. Each of the input valve VN and the relief valve VR is a two-position solenoid valve (also referred to as an “on/off valve”) with an open position (a communicating state) and a closed position (a blocking state). A normally-closed solenoid valve is adopted as the input valve VN. A normally-open solenoid valve is adopted as the relief valve VR. The input valve VN and the relief valve VR are respectively driven (controlled) by drive signals Vn, Vr from the first controller ECA.

The stroke simulator (also simply referred to as the “simulator”) SS is connected to the rear chamber Ro. The simulator SS generates an operation force Fp of the braking operation member BP. A piston and an elastic body (for example, a compression spring) are provided in the simulator SS. When the brake fluid BF flows into the simulator SS, the piston is pushed by the brake fluid BF. Since the elastic body applies a force to the piston in a direction to inhibit an inflow of the brake fluid BF, the operation force Fp of the braking operation member BP is generated. That is, an operation characteristic of the braking operation member BP (a relationship between operation displacement Sp and the operation force Fp) is defined by the simulator SS.

The simulator pressure sensor PB is provided to detect a hydraulic pressure Pb in the simulator SS (referred to as a “simulator pressure”). The simulator pressure sensor PB is one of the braking operation amount sensors BA described above. The simulator pressure Pb is input, as the braking operation amount Ba, to the first controller ECA. Here, the simulator pressure Pb is equal to a hydraulic pressure Pn (an input pressure) in the input chamber Rn and a hydraulic pressure Po (a rear pressure) in the rear chamber Ro.

As the braking operation amount sensor BA, in addition to the simulator pressure sensor PB, the first pressure regulation unit YA is provided with an operation displacement sensor SP that detects the operation displacement Sp of the braking operation member BP and/or an operation force sensor FP that detects the operation force Fp of the braking operation member BP. That is, at least one of the simulator pressure sensor PB, the operation displacement sensor SP (a stroke sensor), and the operation force sensor FP (a depression force sensor) is adopted as the braking operation amount sensor BA. Thus, the braking operation amount Ba is at least one of the simulator pressure Pb, the operation displacement Sp, and the operation force Fp.

The first fluid unit HA further includes a pressure accumulation fluid pump QA, a pressure accumulation electric motor MA, an accumulator AC, an accumulator pressure sensor PC, a pressurization cylinder CK, a pressurization piston NK, a pressure increase valve UZ, a pressure reduction valve UG, and a servo pressure sensor PU, so as to supply a servo pressure Pu to the servo chamber Ru and generate a master pressure Pm.

The pressure is accumulated in the accumulator AC by the pressure accumulation fluid pump QA. The pressure accumulation fluid pump QA (also referred to as a “first fluid pump”) is driven by the pressure accumulation electric motor MA (also referred to as a “first electric motor”) and pumps the brake fluid BF from the master reservoir RV. Then, the brake fluid BF that has discharged from the fluid pump QA is accumulated in the accumulator AC. The brake fluid BF, which has been pressurized to an accumulator pressure Pc, is accumulated in the accumulator AC. The accumulator pressure sensor PC is provided to detect the accumulator pressure Pc. The pressure accumulation electric motor MA (the first electric motor) is controlled to maintain the accumulator pressure Pc within a predetermined range.

The pressurization piston NK is inserted in the pressurization cylinder CK. The inside of the pressurization cylinder CK is divided into three hydraulic chambers Rp (a pilot chamber), Rv (an annular chamber), Rk (a pressurization chamber). The pilot chamber Rp and the pressurization chamber Rk are arranged to hold the pressurization piston NK therebetween. That is, in the pressurization cylinder CK, the pilot chamber Rp is positioned on an opposite side of the pressurization piston NK from the pressurization chamber Rk. A hydraulic pressure Pp (referred to as a “pilot pressure”) that is regulated by the pressure increase valve UZ and the pressure reduction valve UG is supplied to the pilot chamber Rp. Here, the pilot pressure Pp is regulated with the accumulator pressure Pc as a source pressure.

An annular recess (a constricted portion) is provided to an outer circumferential portion of the pressurization piston NK. The annular chamber Rv is formed by this annular recess and an inner circumferential portion of the pressurization cylinder CK. Furthermore, a valve body Vv (for example, a spool valve) is formed on the outer circumferential portion of the pressurization piston NK. Then, the brake fluid BF, which has been pressurized to the accumulator pressure Pc, is supplied from the accumulator AC to this valve body Vv. The accumulator pressure Pc is regulated by the valve body Vv and is introduced into the annular chamber Rv. The annular chamber Rv communicates with the pressurization chamber Rk via a through-hole provided to the pressurization piston NK. Thus, the hydraulic pressure in the annular chamber Rv is the same as the hydraulic pressure in the pressurization chamber Rk. Such a hydraulic pressure will be referred to as the “servo pressure Pu”.

More specifically, when the pressurization piston NK is moved by the hydraulic pressure Pp (the pilot pressure) in the pilot chamber Rp, an open amount of the valve body Vv is changed. Then, the brake fluid BF is supplied from the accumulator AC through the valve body Vv of the pressurization piston NK such that the pilot pressure Pp matches the servo pressure Pu (the hydraulic pressures in the annular chamber Rv and the pressurization chamber Rk). That is, the high accumulator pressure Pc is throttled by the valve body Vv and regulated to the servo pressure Pu. The servo pressure sensor PU is provided to detect the actual servo pressure Pu. Since the pressurization chamber Rk and the servo chamber Ru are connected by the servo path (a fluid path) HU, the brake fluid BF that has been regulated to the servo pressure Pu is supplied to the servo chamber Ru.

Along the center axis Jm of the master cylinder CM (is also a “center axis of the first and second master pistons NP, NS”), the servo chamber Ru is arranged on an opposite side of the first and second master pistons NP, NS from the front-wheel and rear-wheel master chambers Rmf, Rmr (=Rm). Accordingly, a thrust force Fm (referred to as a “master thrust force”) generated by the hydraulic pressures Pmf, Pmr (the front-wheel and rear-wheel master pressures) in the front-wheel and rear-wheel master chambers Rmf, Rmr oppose a thrust force Fu (referred to as a “servo thrust force”) generated by the servo pressure Pu along the center axis Jm. In a normal state (that is, a state where the bottoming out is not occurring), the master thrust force Fm and the servo thrust force Fu are statically balanced. In other words, the master pressure Pm (=Pmf, Pmr) is regulated (increased/reduced) by regulating (increasing/reducing) the servo pressure Pu.

A relationship between the servo pressure Pu and the master pressure Pm is defined by a relationship between a pressure-receiving area ru of the servo chamber Ru (an area of the collar of the first master piston NP, and also referred to as a “servo area”) and a pressure-receiving area rm of the master chamber Rm (an area of the end surface of the second master piston NS, and also referred to as a “master area”). Statically, the servo thrust force Fu is equal to the master thrust force Fm, and thus a relationship “Pu·ru=Pm·rm” is established. Consequently, the master pressure Pm is output as a value that is acquired by multiplying the servo pressure Pu by “a ratio of the servo area ru to the master area rm”.

For example, in the first pressure regulation unit YA, the pressure-receiving area ru (the servo area) of the servo chamber Ru is set to be equal to the pressure-receiving area rm (the master area) of the master chamber Rm. In this case, the front-wheel and rear-wheel master pressures Pmf, Pmr are normally equal to the servo pressure Pu. That is, since “ru=rm”, “Pm=Pu”.

### <<Actuation of First Pressure Regulation Unit YA>>

In the first pressure regulation unit YA, the first fluid unit HA is controlled by the first controller ECA. The first controller ECA receives the braking operation amount Ba, the accumulator pressure Pc, the servo pressure Pu, and the master pressure Pm. Here, the master pressure Pm is transmitted from the second controller ECB and input to the first controller ECA via the communication bus BS. Based on these signals, a drive signal Vn for the input valve VN, a drive signal Vr for the relief valve VR, a drive signal Uz for the pressure increase valve UZ, a drive signal Ug for the pressure reduction valve UG, and a drive signal Ma for the pressure accumulation electric motor MA are calculated in the first controller ECA. Then, the solenoid valves “VN, VR, UZ, UG” constituting the first pressure regulation unit YA and the pressure accumulation electric motor MA are controlled (driven) according to the drive signals “Vn, Vr, Uz, Ug, Ma”. In addition, as will be described below, the required pressure Ps, the target pressure Pt, and the determination result (the determination flag) FL of the bottoming state are calculated in the first controller ECA, and these are transmitted to the second controller ECB through the communication bus BS.

During non-braking (that is, when the braking operation member BP is not operated), the pistons “NN, NP, NS” are pressed in the withdrawal direction Hb by the springs “DN, DP, DS” and return to initial positions of those (positions moved the farthest in the withdrawal direction Hb). In this state, the front-wheel and rear-wheel master chambers Rmf, Rmr and the master reservoir RV are in a communicating state, and the front-wheel and rear-wheel master pressures Pmf, Pmr are “0 (the atmospheric pressure)”. In addition, at the initial position of each of the pistons, the input piston NN and the first master piston NP have a clearance Ks.

During non-braking, the pressure increase valve UZ is closed, and the pressure reduction valve UG is opened. Thus, the pilot chamber Rp and the master reservoir RV are in the communicating state, and the pilot pressure Pp is “0 (the atmospheric pressure)”. Then, the pressurization piston NK is pressed against a bottom of the pressurization cylinder CK by a compression spring DK, and the valve body Vv (a spool valve) is closed. Since the pressurization chamber Rk and the master reservoir RV are in the communicating state, the servo pressure Pu is also “0”. Furthermore, during non-braking, the input valve VN and the relief valve VR are opened, and the rear chamber Ro and the input chamber Rn are in the communicating state with the master reservoir RV. Thus, the internal pressures Po, Pn in these hydraulic chambers are also “0”. That is, during non-braking, it is in a state of “Pmf=Pmr=Pp=Pu=Po=Pn=0”.

During braking (that is, when the braking operation member BP is operated), the input valve VN is opened, and the relief valve VR is closed. That is, the input chamber Rn and the rear chamber Ro are in the communicating state while the communicating state between the rear chamber Ro and the master reservoir RV is shut off and thus are in a non-communicating state. With an increase in the operation amount Ba of the braking operation member BP, the input piston NN is moved in the advancing direction Ha, and the brake fluid BF is discharged from the input chamber Rn. Since this brake fluid BF is absorbed by the stroke simulator SS, the hydraulic pressure Pn (the input pressure) in the input chamber Rn and the hydraulic pressure Po (the rear pressure) in the rear chamber Ro are increased, and the operation force Fp that corresponds to the operation displacement Sp is generated in the braking operation member BP.

During braking, based on the braking operation amount Ba (at least one of the simulator pressure Pb, the operation displacement Sp, and the operation force Fp), the pressure increase valve UZ and the pressure reduction valve UG are controlled, and the hydraulic pressure Pp (the pilot pressure) in the pilot chamber Rp is increased. In response to the increase in the pilot pressure Pp, the valve body Vv is opened, and the hydraulic pressure Pu (the servo pressure) in the annular chamber Rv and the pressurization chamber Rk is increased. The servo pressure Pu is supplied to the servo chamber Ru via the servo path HU. The first master piston NP is pressed and moved in the advancing direction Ha by the servo thrust force Fu that corresponds to the servo pressure Pu. Along with the movement of the first master piston NP in the advancing direction Ha, the front-wheel and rear-wheel master pressures Pmf, Pmr (=Pm) are increased. Then, the brake fluid BF, which has been regulated to the master pressure Pm, is supplied from the first pressure regulation unit YA to the second pressure regulation unit YB, and the hydraulic pressure Pw in the wheel cylinder CW is eventually increased.

The braking control device SC is of a so-called brake-by-wire type. Thus, in the case where the vehicle is an electric vehicle (for example, an electric car or a hybrid car), regenerative cooperative control can be executed. In the first fluid unit HA of the first pressure regulation unit YA, the input piston NN and the first master piston NP has the clearance Ks. By controlling the servo pressure Pu, a relative positional relationship between the input piston NN and each of the first and second master pistons NP, NS can be adjusted appropriately within a range of this clearance. For example, when only the braking force generated by regenerative braking is necessary, “Pu=0” is set, and the master pressure Pm remains “0”. The braking force generated by friction between the rotary member KT and the friction member MS is not generated, and only a regenerative braking force by a drive electric motor, which is actuated as a generator, is generated.

### <Second Pressure Regulation Unit YB>

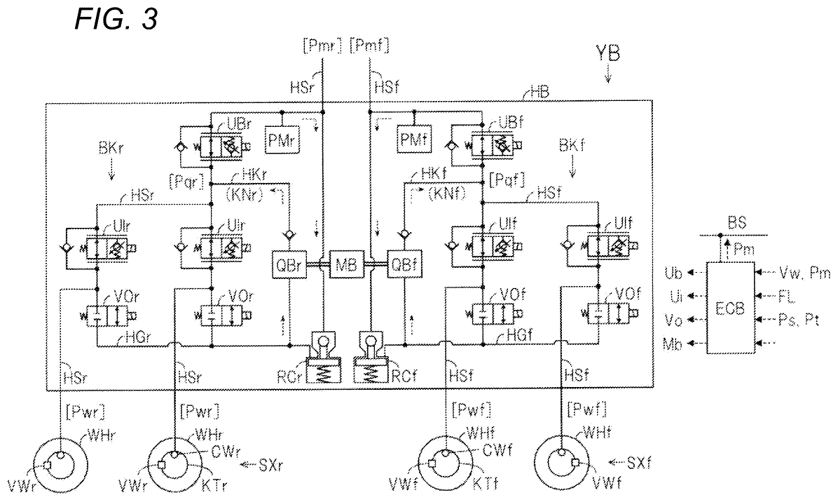

A description will be made on a configuration example of the second pressure regulation unit (the lower pressure regulation unit) YB with reference to a schematic view in FIG. 3. In the communication path HS (the fluid path), the second pressure regulation unit YB is provided between the first pressure regulation unit YA and the wheel cylinder CW. The braking control device SC can regulate (increase, keep, or reduce) the master pressure Pm by the second pressure regulation unit YB. The second pressure regulation unit YB is configured to include the second fluid unit HB and the second controller ECB controlling the second fluid unit HB.

The second fluid unit HB includes the pressure regulator UB, a master pressure sensor PM, the reflux fluid pump QB (also referred to as a “second fluid pump”), a recirculation electric motor MB (also referred to as a “second electric motor”), a pressure regulation reservoir RC, an inlet valve UI, and an outlet valve VO.

The front-wheel and rear-wheel pressure regulators UBÍ, UBr (=UB) are provided to the front-wheel and rear-wheel communication paths HSf, HSr (=HS), respectively. The pressure regulator UB (the solenoid valve) is a normally-open linear valve (also referred to as a “differential pressure valve” and a “proportional valve”). An upper portion of the pressure regulator UB (a portion of the communication path HS on a side near the first pressure regulation unit YA) and a lower portion of the pressure regulator UB (a portion of the communication path HS on a side near the wheel cylinder CW) are connected by the front-wheel and rear-wheel recirculation paths HKf, HKr (=HK). The recirculation paths HK is provided with the front-wheel and rear-wheel recirculation fluid pump QBf, QBr (=QB) and the front-wheel and rear-wheel pressure regulation reservoirs RCf, RCr (=RC). The recirculation fluid pump QB (the second fluid pump) is driven by the recirculation electric motor MB (the second electric motor).

The front-wheel and rear-wheel master pressure sensors PMf, PMr (=PM) are provided to detect the front-wheel and master-wheel master pressures Pmf, Pmr (=Pm). The master pressure Pm (the hydraulic pressure in the master chamber Rm) is supplied by the first pressure regulation unit YA (in particular, the servo pressure Pu). The master pressure sensor PM is arranged to the upper portion of the pressure regulator UB (a portion between the master cylinder CM and the pressure regulator UB).

When the second electric motor MB is rotationally driven, the brake fluid BF is suctioned from the upper portion of the pressure regulator UB and is discharged to the lower portion of the pressure regulator UB by the second fluid pump QB. In this way, in the communication path HS and the recirculation path HK, a circulation flow KN of the brake fluid BF (that is, front-wheel and rear-wheel recirculation flows KNf, KNr, flows of the circulating brake fluid BF), which includes the pressure regulator UB, the fluid pump QB, and the pressure regulation reservoir RC, is generated. When the circulation flow KN of the brake fluid BF is throttled by the pressure regulator UB, due to an orifice effect, a hydraulic pressure Pq (referred to as a “regulated pressure”) in the lower portion of the pressure regulator UB is increased to be higher than the master pressure Pm in the upper portion of the pressure regulator UB. That is, the second pressure regulation unit YB can increase and regulate the front-wheel and rear-wheel pressures Pwf, Pwr (=Pw) from the front-wheel and rear-wheel master pressures Pmf, Pmr, respectively.

In the second pressure regulation unit YB, each of the front-wheel and rear-wheel communication paths HSf, HSr is branched into two and connected to respective one of the front and rear wheel cylinders CWf, CWr. The inlet valve UI and the outlet valve VO are provided for each of the wheel cylinders CW. Similar to the pressure regulator UB, the inlet valve UI (the solenoid valve) is a normally-open linear valve. However, an opening direction differs between the pressure regulator UB and the inlet valve UI. In detail, the pressure regulator UB is opened in a manner to respond to a flow of the brake fluid BF from the wheel cylinder CW side (the lower side) to the master cylinder CM side (the upper side). Thus, the regulated pressure Pq becomes equal to or higher than the master pressure Pm (that is, “Pq≥ Pm”) by the pressure regulation using the pressure regulator UB. Meanwhile, the inlet valve UI is opened in a manner to respond to a flow from the pressure regulator UB side (the upper side) to the wheel cylinder CW side (the lower side). Thus, the wheel pressure Pw becomes equal to or lower than the regulated pressure Pq (that is, “Pq>Pw”) by the pressure regulation using the inlet valve UI.

The inlet valve UI is provided to the branched communication path HS (that is, a side near the wheel cylinder CW with respect to a branched portion of the communication path HS). In a lower portion of the inlet valve UI (a portion of the communication path HS on a side near the wheel cylinder CW), the communication path HS is connected to the pressure regulation reservoir RC via the pressure reduction path HG. The outlet valve VO as a normally-closed on/off valve is arranged to the pressure reduction path HG.

The inlet valve UI and the outlet valve VO are controlled separately such that the wheel pressure Pw is regulated separately for each of the wheel cylinders CW. In order to reduce the wheel pressure Pw, the inlet valve UI is closed, and the outlet valve VO is opened. Since the flow of the brake fluid BF into the wheel cylinder CW is inhibited, and the brake fluid BF in the wheel cylinder CW flows into the pressure regulation reservoir RC, the wheel pressure Pw is reduced. In order to increase the wheel pressure Pw, the inlet valve UI is opened, and the outlet valve VO is closed. Since the flow of the brake fluid BF into the pressure regulation reservoir RC is inhibited, and the regulated pressure Pq from the pressure regulator UB is supplied to the wheel cylinder CW, the wheel pressure Pw is increased. In order to keep the wheel pressure Pw, both of the inlet valve UI and the outlet valve VO are closed. Since the wheel cylinder CW is sealed fluidly, the wheel pressure Pw is maintained to be constant.

In the second pressure regulation unit YB, the second fluid unit HB is controlled by the second controller ECB. Here, the second controller ECB and the first controller ECA are connected via the communication bus BS so as to be able to share the information. The second controller ECB receives the wheel speed Vw, the master pressure Pm, the steering amount Sa, the yaw rate Yr, the front-rear acceleration Gx, the lateral acceleration Gy, and the like. In addition, the second controller ECB receives the required pressure Ps, which is calculated by the first controller ECA, the target pressure Pt, the determination flag FL, and the like through the communication bus BS. In the second controller ECB, a drive signal Ub for the pressure regulator UB, a drive signal Ui for the inlet valve UI, a drive signal Vo for the outlet valve VO, and a drive signal Mb for the second electric motor MB are calculated on the basis of these signals. Then, the solenoid valves “UB, UI, VO” constituting the second fluid unit HB and the second electric motor MB are controlled (driven) according to these drive signals (Ub and the like).

### <Processing in Pressure Regulation Control>

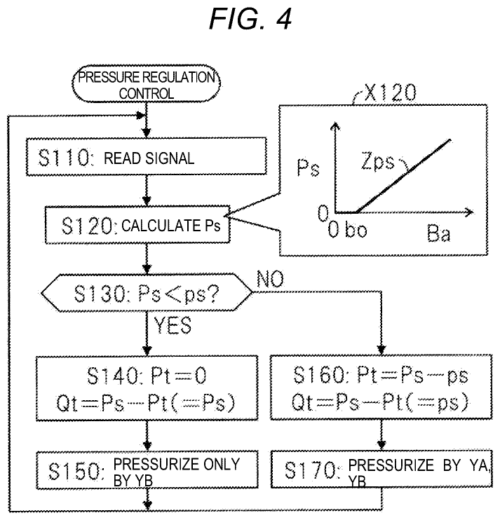

A description will be made on a processing example of the pressure regulation control by the braking control device SC with reference to a flowchart in FIG. 4. The “pressure regulation control” is one using the first pressure regulation unit YA and the second pressure regulation unit YB as pressurization sources to electrically generate and regulate the wheel pressure Pw. Algorithms for the pressure regulation control are programmed into microprocessors in the first and second controllers ECA, ECB. In the following description, such a configuration that the servo area ru and the master area rm are equal to each other is assumed. In a configuration that the servo area ru differs from the master area rm, a relationship between the required pressure Ps (a target value of the wheel pressure Pw) and the target pressure Pt (a target value of the servo pressure Pu) is converted on the basis of a ratio between the servo area ru and the master area rm.

In step S110, the various signals including the braking operation amount Ba, the servo pressure Pu, and the like are read. Here, the braking operation amount Ba (a collective term for state amounts representing a degree of the operation of the braking operation member BP) is detected by the braking operation amount sensor BA. The servo pressure Pu is detected by the servo pressure sensor PU.

In step S120, the required pressure Ps (a variable) is calculated on the basis of the operation amount Ba of the braking operation member BP. The required pressure Ps is a target value of the hydraulic pressure Pw (the actual value) in each of the wheel cylinders CW, corresponding to vehicle deceleration requested by the driver, and is calculated to be equal in a front-wheel braking system BKf and in a rear-wheel braking system BKr. More specifically, as indicated in a block X120, the required pressure Ps is determined on the basis of the braking operation amount Ba (the variable) and a calculation map Zps, which is set in advance. Further specifically, the required pressure Ps is calculated to be “0” within a range from “0” to an amount of play bo of the braking operation amount Ba. Then, within a range where the braking operation amount Ba is equal to or larger than the amount of play bo, the required pressure Ps is calculated to be increased from “0” with the increase in the braking operation amount Ba. That is, when “Ba≥ bo”, the required pressure Ps is determined to be increased with the increase in the braking operation amount Ba according to the calculation map Zps. Here, the amount of play bo is a predetermined value (a constant) that is set in advance, and corresponds to play of the braking operation member BP.

In step S130, it is determined whether “the required pressure Ps is lower than a region determination pressure ps (referred to as a “low hydraulic pressure region determination” and also simply referred to as a “region determination”)” on the basis of the required pressure Ps. If the required pressure Ps is lower than the region determination pressure ps, and the region determination is positive, the processing proceeds to step S140. On the other hand, if the required pressure Ps is equal to or higher than the region determination pressure ps, and the region determination is negative, the processing proceeds to step S160. Here, the region determination pressure ps is a threshold value for determining a low hydraulic pressure region, and is a predetermined value (a constant) that is set in advance.

In step S140, the target pressure Pt and the target differential pressure Qt, which correspond to the region where the required pressure Ps (resulting the wheel pressure Pw) is relatively low (referred to as the “low hydraulic pressure region”), are calculated. The target pressure Pt (=Ptf, Ptr) is a target value of the hydraulic pressure to be achieved by the first pressure regulation unit YA. The front-wheel target pressure Ptf and the rear-wheel target pressure Ptr are determined to be equal (that is, “Ptf=Ptr”). The target differential pressure Qt (=Qtf, Qtr) is a target value of a differential pressure (a hydraulic pressure difference between the master pressure Pm and the wheel pressure Pw) to be achieved by the second pressure regulation unit YB. The front-wheel target differential pressure Qtf and the rear-wheel target differential pressure Qtr are determined to be equal (that is, “Qtf=Qtr”). In other words, in step S140, the required pressure Ps is broken down to the target pressure Pt and the target differential pressure Qt. Thus, the required pressure Ps is equal to a sum “Pt+Qt” of the target pressure Pt and the target differential pressure Qt. In addition, since the calculations are performed using “Ptf=Ptr, Qtf=Qtr”, the wheel pressure Pw is controlled to be equal in all the wheel cylinders CW.

In step S140, the target pressure Pt is determined to be “0”, and the target differential pressure Qt is determined as a value that is acquired by subtracting the target pressure Pt from the required pressure Ps (that is, “Pt=0, Qt=Ps−Pt=Ps”). That is, in the low hydraulic pressure region where the wheel pressure Pw is low, the first pressure regulation unit YA is not adopted, and only the second pressure regulation unit YB is used to regulate the wheel pressure Pw. This is to ensure that a characteristic of “pressure regulation accuracy by the second pressure regulation unit YB being high” is exerted in the low hydraulic pressure region.

In step S150, the first and second pressure regulation units YA, YB are controlled on the basis of the target pressure Pt and the target differential pressure Qt. More specifically, since “Pt=0”, the pressure increase valve UZ and the pressure reduction valve UG are not energized, and the pilot pressure Pp remains “0”. In this way, the closed state of the valve body Vv is maintained, and the servo pressure Pu is set to “0”. Thus, the master pressure Pm that is the output from the first pressure regulation unit YA (in particular, the first fluid unit HA) is set to “0”.

Meanwhile, in step S150, the second pressure regulation unit YB (in particular, the second fluid unit HB) is controlled on the basis of the target differential pressure Qt (=Ps). More specifically, the electric motor MB is first driven. In this way, the fluid pump QB produces the circulation flow KN of the brake fluid. Then, the pressure regulator UB is energized on the basis of the target differential pressure Qt. In detail, since a relationship (a so-called IP characteristic) between a supply current Ib to the pressure regulator UB and the target differential pressure Qt is set as a calculation map Zip in advance, the current Ib flows into the pressure regulator UB on the basis of the target differential pressure Qt and the calculation map Zip. Since an open amount of the pressure regulator UB is reduced according to the supply current the circulation flow KN is throttled, and an actual differential pressure mQ (an actual difference between the master pressure Pm and the regulated pressure Pq) is increased. In the calculation map Zip, it is set that the supply current Ib is increased with the increase in the target differential pressure Qt.

In step S160, the target pressure Pt (=Ptf, Ptr) and the target differential pressure Qt (=Qtf, Qtr) in a situation where the required pressure Ps (resulting the wheel pressure Pw) is outside the low hydraulic pressure region are calculated. Similar to step S140, in step S160, the required pressure Ps is acquired by the target pressure Pt and the target differential pressure Qt. Thus, the relationship of “Ps=Pt+Qt” is established. In step S160, the target pressure Pt is determined to be a “value acquired by subtracting the region determination pressure ps from the required pressure Ps”, and the target differential pressure Qt is determined as a value acquired by subtracting the target pressure Pt from the required pressure Ps (that is, “Pt=Ps−ps, Qt=Ps−Pt=ps”). In a hydraulic pressure region where the wheel pressure Pw is relatively high (a region above the low hydraulic pressure region described above), both of the first and second pressure regulation units YA, YB are used to regulate the wheel pressure Pw.

In step S170, the first and second pressure regulation units YA, YB are controlled on the basis of the target pressure Pt and the target differential pressure Qt. More specifically, in the first pressure regulation unit YA (in particular, the first fluid unit HA), the pressure increase valve UZ and the pressure reduction valve UG are controlled for the upper pressure regulation on the basis of the target pressure Pt and the servo pressure Pu such that the servo pressure Pu approaches and matches the target pressure Pt. In detail, when “Pu<Pt”, the servo pressure Pu is increased by at least one of an increase in an open amount of the pressure increase valve UZ and a reduction in an open amount of the pressure reduction valve UG. On the other hand, when “Pu>Pt”, the servo pressure Pu is reduced by at least one of a reduction in the open amount of the pressure increase valve UZ and an increase in the open amount of the pressure reduction valve UG.

Furthermore, in step S170, in the second pressure regulation unit YB (in particular, the second fluid unit HB), the pressure regulator UB is controlled for lower pressure regulation on the basis of the target differential pressure Qt (=ps). Similar to step S150, the second electric motor MB is driven, and the circulation flow KN of the brake fluid BF including the second fluid pump QB and the pressure regulator UB is generated. Then, based on the target differential pressure Qt, the pressure regulator UB is energized, and the actual differential pressure mQ is regulated.

The second pressure regulation unit YB is a general-purpose unit that is essentially used for the vehicle stability control and the like, and has the excellent accuracy in regulating the wheel pressure Pw. In the braking control device SC, this characteristic is used for the service brake. More specifically, in the region where the wheel pressure Pw is relatively low (“Ps<ps”), the upper pressure regulation by the first pressure regulation unit YA is not adopted, and the wheel pressure Pw is regulated only by the lower pressure regulation by the second pressure regulation unit YB. Meanwhile, the supply of the high pressure by the second pressure regulation unit YB requires to increase a rotational speed of the second electric motor MB, which is disadvantageous in terms of actuation noise. To handle this, in the area where the wheel pressure Pw is relatively high (when “Ps>ps”), the wheel pressure Pw is regulated by both of the upper pressure regulation and the lower pressure regulation. By using the upper pressure regulation and the lower pressure regulation separately, the braking control device SC executes the quiet and highly accurate pressure regulation control.

### <Bottoming Processing>

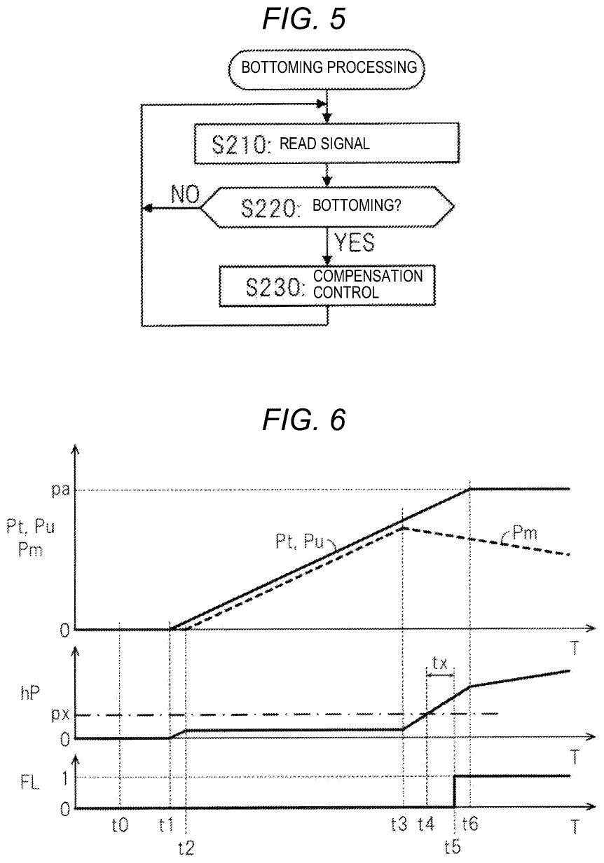

A description will be made on bottoming processing for the first and second master pistons NP, NS with reference to a flowchart in FIG. 5. “Bottoming” is a state where the first and second master pistons NP, NS reach movable limit positions thereof in the advancing direction Ha, and is also referred to as “master bottoming”. Bottoming out of the first and second master pistons NP, NS occurs in a situation where the brake fluid leaks outside the braking control device SC. In some cases, the bottoming out of the first and second master pistons NP, NS occurs due to a brake fade phenomenon (also simply referred to as a “fade”). In the fade, rubber, a resin, or the like as a material of the friction member MS (for example, the brake pad) increases a temperature thereof to exceed a heat-resistant temperature, is thermally decomposed, and is gasified. The gas then enters between the friction member MS and the rotary member KT (for example, the brake disc) to form a gas film. This gas film acts like a lubricant and reduces a friction coefficient. When the fade further occurs, the material (in particular, a base material such as a phenolic resin as a thermosetting resin) of the friction member is decomposed and becomes brittle. At this time, in addition to the reduction in the friction coefficient, rapid wear (for example, a few millimeters of wear in single braking action, referred to as “fade wear”) can occur.

When the master bottoming occurs, it becomes difficult to increase the master pressure Pm. In detail, in the case where the first master piston NP bottoms out, the front-wheel master pressure Pmf is no longer increased. In the case where the second master piston NS bottoms out, the rear-wheel master pressure Pmr is no longer increased.

Hereinafter, a description will be made on, as the “bottoming processing”, identification of occurrence of the master bottoming and a procedure to be taken when the bottoming out is identified (referred to as “compensation control”). For example, the bottoming processing is programmed into the microprocessor in the first controller ECA. In the following description, the configuration “ru=rm” is also assumed in the first fluid unit HA.

In step S210, the servo pressure Pu, the master pressure Pm (=Pmf, Pmr), and the like are read. The servo pressure Pu is a detection value by the servo pressure sensor PU and is directly input to the first controller ECA. The front-wheel and rear-wheel master pressures Pmf, Pmr are detection values by the front-wheel and rear-wheel master pressure sensors PMf, PMr and are directly input to the second controller ECB. Then, the front-wheel and rear-wheel master pressures Pmf, Pmr are transmitted from the second controller ECB to the first controller ECA through the communication bus BS.

In step S220, it is determined “whether the bottoming state occurs to the first and second master pistons NP, NS (referred to as a “bottoming determination”)” on the basis of the servo pressure Pu and the front-wheel and rear-wheel master pressures Pmf, Pmr. More specifically, the servo pressure Pu is compared to the front-wheel master pressure Pmf, and, in the case where a difference hPf (a front-wheel pressure difference) between the servo pressure Pu and the front-wheel master pressure Pmf exceeds a predetermined pressure px, the bottoming state of the first master piston NP is determined. Similarly, the servo pressure Pu is compared to the rear-wheel master pressure Pmr, and, in the case where a difference hPr (a rear-wheel pressure difference) between the servo pressure Pu and the rear-wheel master pressure Pmr exceeds the predetermined pressure px, the bottoming state of the second master piston NS is determined. Here, the predetermined pressure px is a threshold value for the bottoming determination and is a predetermined value (a constant) that is set in advance. The pressure differences hPf, hPr will also be referred to as a “determination hydraulic pressure difference” or a “determination differential pressure” in order to be distinguished from the “hydraulic pressure difference mQ by the pressure regulator UB” and the “hydraulic pressure difference wO by the inlet valve UI”.

In the case where the bottoming out occurs in the front-wheel braking system BKf, the first master piston NP is restricted from being moved in the advancing direction Ha by the second master piston NS, and reaches a limit position. Since the first master piston NP and the second master piston NS are moved together, the relationship of “Pu=Pmf” is no longer established. Accordingly, in the case where the front-wheel pressure difference hPf (=Pu-Pmf) becomes greater than the predetermined pressure px, the bottoming state of the first master piston NP is determined. Here, in the case where the bottoming out does not occur in the rear-wheel braking system BKr while the bottoming out occurs in the front-wheel braking system BKf, the rear-wheel master pressure Pmr can be regulated by the servo pressure Pu.

In the case where the bottoming out occurs in the rear-wheel braking system BKr, motion of the second master piston NS in the advancing direction Ha is restricted by the bottom surface of the master cylinder CM. Thus, “Pu=Pmr” is no longer established. Similarly, in the case where the rear-wheel pressure difference hPr (=Pu-Pmr) becomes greater than the predetermined pressure px, the bottoming state of the second master piston NS is determined. In the case where the bottoming out does not occur in the front-wheel braking system BKf while the bottoming out occurs in the rear-wheel braking system BKr, the front-wheel master pressure Pmf can be regulated by the servo pressure Pu.

If at least one of the first and second master pistons NP, NS is in the bottoming state, and it is determined YES in step S220, the processing proceeds to step S230. On the other hand, if the bottoming out does not occur to either one of the first and second master pistons NP, NS, it is determined NO in step S220, and the processing returns to step S210.

In step S230, the compensation control is executed. In the “compensation control”, in the case where the bottoming state occurs, in order to reduce (compensate for) an impact thereof, a calculation method for the front-wheel and rear-wheel target differential pressures Qtf, Qtr (=Qt) is changed. The master pressure Pm is increased by the pressure regulator UB and is supplied as the regulated pressure Pq (eventually, the wheel pressure Pw) to the wheel cylinder CW. Meanwhile, the target differential pressure Qt is a target value that represents a degree (that is, a difference between the master pressure Pm and the regulated pressure Pq) to increase the master pressure Pm, and is also referred to as a “first target differential pressure”.

First, a description will be made on the case where the bottoming state of the first master piston NP is determined. In the service brake, in step S140 or step S160, the front-wheel target differential pressure Qtf is calculated by subtracting the front-wheel target pressure Ptf from the required pressure Ps (that is, “Qtf=Ps−Ptf”). In the case where the bottoming out occurs in the front-wheel braking system BKf, the front-wheel master pressure Pmf (the detection value by the front-wheel master pressure sensor PMf, and is the actual value) is used instead of the front-wheel target pressure Ptf (the target value). That is, the front-wheel target differential pressure Qtf is determined by subtracting the front-wheel master pressure Pmf from the required pressure Ps (that is, “Qtf=Ps−Pmf”). While the front-wheel master pressure Pmf is gradually reduced by the rapid wear (the fade wear) of the front-wheel friction member MSf or the like, the front-wheel target differential pressure Qtf is increased to compensate for the reduction in the front-wheel master pressure Pmf. In this way, the reduction in the deceleration of the vehicle JV is suppressed. Since the bottoming out does not occur in the rear-wheel braking system BKr, the rear-wheel target differential pressure Qtr is calculated by subtracting the rear-wheel target pressure Ptr from the required pressure Ps (that is, “Qtr=Ps−Ptr”).

Next, a description will be made on the case where the bottoming state of the second master piston NS is determined. Similar to the above, the rear-wheel target differential pressure Qtr is calculated by subtracting the rear-wheel target pressure Ptr (the target value) from the required pressure Ps. However, in the case where the bottoming out occurs in the rear-wheel braking system BKr, the rear-wheel target differential Qtr pressure is determined by subtracting the rear-wheel master pressure Pmr (the detected actual value) from the required pressure Ps (that is, “Qtr=Ps−Pmr”). In this way, the rear-wheel target differential pressure Qtr is increased to compensate for the reduction in the rear-wheel master pressure Pmr, and the reduction in the vehicle deceleration is suppressed. Since the bottoming out does not occur in the front-wheel braking system BKf, the front-wheel target differential pressure Qtf is calculated by subtracting the front-wheel target pressure Ptf from the required pressure Ps (that is, “Qtf=Ps−Ptf”).

As it has been described so far, when the bottoming state of the first master piston NP is determined, the calculation method for the front-wheel target differential pressure Qtf is changed, so as to change the front-wheel target differential pressure Qtf to be increased. In this way, the reduction in the front-wheel master pressure Pmf is compensated by the second pressure regulation unit YB. On the contrary, when the bottoming state of the second master piston NS is determined, the calculation method for the rear-wheel target differential pressure Qtr is changed, so as to change the rear-wheel target differential pressure Qtr to be increased. In this way, the reduction in the rear-wheel master pressure Pmr is compensated by the second pressure regulation unit YB.

That is, in the second pressure regulation unit YB, in the case where the occurrence of the bottoming out to either one of the first and second master pistons NP, NS is determined, the target differential pressure of the front-wheel and rear-wheel target differential pressures Qtf, Qtr (=Qt), which corresponds to the one having bottomed out, is regulated to be higher than that when such occurrence is not determined. As a result, the degrees (that is, the front-wheel and rear-wheel actual differential pressures) mQf, mQr (the actual difference between the master pressure Pm and the regulated pressure Pq) to increase the front-wheel and rear-wheel master pressures Pmf, Pmr are increased. Thus, the reductions in the front-wheel and rear-wheel master pressures Pmf, Pmr, which are caused by the bottoming out, are compensated. Furthermore, since the bottoming state of each of the first and second master pistons NP, NS is determined by the simple calculation, the determination is made in a short period of time. Thus, the reduction in the master pressure Pm is compensated promptly by the second pressure regulation unit YB.

In consideration of a change in a perpendicular force (a wheel load) during braking, in the vehicle JV, a braking load on the front wheel WHf is set to be larger than a braking load on the rear wheel WHr. Accordingly, a probability of the occurrence of the above fade wear is higher to the friction member MSf of the front wheel WHf than to the friction member Msr of the rear wheel WHr. Since the front-wheel master pressure Pmf and the rear-wheel master pressure Pmr are substantially equal during normal time (that is, when the bottoming out does not occur), the rear-wheel master pressure sensor PMr may be omitted. In such a configuration, the bottoming state of the second master piston NS cannot be determined on the basis of the comparison between the servo pressure Pu and the rear-wheel master pressure Pmr. However, omitting of the rear-wheel master pressure sensor PMr is based on a fact that, due to the above reason, the determination on the bottoming state of the first master piston NP is more important.

In the configuration that the rear-wheel master pressure sensor PMr is omitted, in step S230, as the compensation control, a control method for the rear-wheel inlet valve UIr in the braking force distribution control (the so-called EBD control) is further changed on the basis of the result of the bottoming determination on the first master piston NP.

First, a description will be made on the execution of the braking force distribution control. In the braking control device SC, known braking force distribution control is executed in the following calculation steps on the basis of the wheel speed Vw (the detection result by the wheel speed sensor VW).

(1) A body speed Vx is calculated on the basis of the wheel speed Vw.

(2) Front-wheel and rear-wheel slips Slf, Slr are calculated on the basis of the body speed Vx and the front and rear wheel speeds Vwf, Vwr. The front-wheel and rear-wheel slips Slf, Slr are state amounts that indicate magnitudes of deceleration slips of the front and rear wheels WHf, WHr, respectively.

(3) A target rear wheel pressure Pvr is calculated on the basis of the front-wheel slip Slf and the rear-wheel slip Slr. The target rear wheel pressure Pvr is a target value that corresponds to the actual rear wheel pressure Pwr in the braking force distribution control. The target rear wheel pressure Pvr is determined such that the rear-wheel slip Slr falls within a predetermined range with respect to the front-wheel slip Slf.

(4) A rear-wheel 1 target differential pressure Otr is calculated on the basis of the target rear wheel pressure Pvr. By the rear-wheel inlet valve UIr, a rear-wheel regulated pressure Pqr (the hydraulic pressure between the rear-wheel pressure regulator UBr and the rear-wheel inlet valve UIr) is reduced and supplied to the rear wheel cylinder CWr. The rear-wheel target differential pressure Otr is a target value that represents a degree to reduce the rear-wheel regulated pressure Pqr (that is, the difference between the rear-wheel regulated pressure Pqr and the rear wheel pressure Pwr), and is also referred to as a “second target differential pressure (a target value of the differential pressure by the inlet valve UIr)” so as to be distinguished from the “first target differential pressure (the target value of the differential pressure by the pressure regulator UB)” described above.

(5) The rear-wheel inlet valve UIr is controlled according to the rear-wheel target differential pressure Otr. That is, the supply current to the rear-wheel inlet valve UIr is controlled such that an actual differential pressure wOr (the hydraulic pressure difference between the rear wheel pressure Pwr and the rear-wheel regulated pressure Pqr) that is generated by the rear-wheel inlet valve UIr approaches and matches the rear-wheel target differential pressure Otr.

In the case where the bottoming state of the first master piston NP is not determined, in the above calculation step (4), the second target differential pressure Otr is calculated on the basis of the front-wheel master pressure Pmf (the detection value by the front-wheel master pressure sensor PMf). More specifically, the second target differential pressure Otr is calculated to a value acquired by subtracting the front-wheel master pressure Pmf from the target rear wheel pressure Pvr (that is, “Otr=Pvr−Pmf”). This is based on a fact that “Pmf=Pmr” in a state where the first master piston NP does not bottom out.

When the first master piston NP bottoms out, the relationship of “Pmf=Pmr” is no longer established. Accordingly, in the case where the bottoming state of the first master piston NP is determined, the front-wheel master pressure Pmf is switched to the front-wheel target pressure Ptf in the calculation of the second target differential pressure Otr (that is, “Otr=Pvr−Ptf”). The front-wheel master pressure Pmf is gradually reduced by the bottoming state of the first master piston NP. However, since the front-wheel master pressure Pmf is replaced with the front-wheel target pressure Ptf in the calculation of the second target differential pressure Otr, the rear wheel pressure Pwr is not increased unnecessarily.

### <Operation in Bottoming Determination>

A description will be made on the bottoming determination for identifying the bottoming states of the first and second master pistons NP, NS with reference to time-series graphs (graphs indicating transitions of the state amounts with respect to time T) in FIG. 6. The bottoming state is a state where the movement of each of the first and second master pistons NP, NS in the advancing direction Ha reaches the limit position. In the bottoming state, the volumes of the front-wheel and rear-wheel master chambers Rmf, Rmr are the smallest, and the brake fluid BF can no longer be pumped from the front-wheel and rear-wheel master chambers Rmf, Rmr.

In the example, the following matters are assumed.
At a time point to, the operation of the braking operation member BP is started, and at a time point t6, the braking operation member BP is held constant.
At a time point t3, the bottoming state occurs. Here, the bottoming state does not occur to the second master piston NS but only occurs to the first master piston NP. Accordingly, in the following explanation, and in FIG. 6, “PM” corresponds to “PMf”, “Pt” corresponds to “Ptf”, “Pm” corresponds to “Pmf”, and “hP” corresponds to “hPf” unless otherwise specified. Meanwhile, in the case where the first master piston NP does not bottom out and the second master piston NS bottoms out (the opposite of the above), in the following description, and in FIG. 6, “NP” can be read as “NS”, “PM” as “PMr”, “Pt” as “Ptr”, “Pm” as “Pmr”, and “hP” as “hPr”.
The signal (the master pressure) Pm from the master pressure sensor PM is input to the second controller ECB and is transmitted to the first controller ECA via the communication bus BS. Then, the bottoming determination is made by the first controller ECA. Thus, the master pressure Pm includes a communication-related delay time (a time point t1 to t2) with respect to the servo pressure Pu.
In the configuration of the first fluid unit HA, the servo area ru and the master area rm are set to be equal.

At the time point to, the operation of the braking operation member BP is started, and the braking operation amount Ba starts to increase. The required pressure Ps is increased in response to the increase in the braking operation amount Ba. However, in an initial braking period, the required pressure Ps is lower than the region determination pressure ps and falls within the low hydraulic pressure region (see step S130). Thus, the target pressure Pt remains “0”. As a result, the servo pressure Pu and the master pressure Pm are “0”. Here, since the servo pressure Pu is controlled to match the target pressure Pt, the graph of the target pressure Pt and the graph of the servo pressure Pu are illustrated in an overlapping manner.

At the time point t1, the required pressure Ps becomes equal to or higher than the region determination pressure ps and leaves the low hydraulic pressure region. In conjunction with this, the target pressure Pt and the servo pressure Pu are increased from “0”. Since the master pressure Pm (indicated by a broken line) is received from the second controller ECB, the communication time delay exists between the servo pressure Pu and the master pressure Pm. Accordingly, the master pressure Pm starts to increase at the time point t2, which is slightly delayed from the increase start time point t1 of the servo pressure Pu. None of the first and second master pistons NP, NS bottoms out. Thus, the difference hP between the servo pressure Pu and the master pressure Pm (that is, a value acquired by subtracting the master pressure Pm from the servo pressure Pu) is caused by the communication delay, and a magnitude thereof is small. That is, the servo pressure Pu and the master pressure Pm substantially match each other.

At the time point t3, the bottoming out related to the first master piston NP occurs. Since the movement of the first master piston NP in the advancing direction Ha is constrained, the relationship of “Pu & Pm” is no longer valid. At the time point t3, at which the bottoming out occurs, onward, the master pressure Pm generates less and is sequentially reduced. Consequently, the pressure difference hP (=Pu−Pm) is sequentially increased. At a time point t4, the pressure difference hP (the determination differential pressure) becomes equal to or greater than the predetermined pressure px for the first time. However, at the time point t4, the bottoming state of the first master piston NP is not determined immediately. The bottoming state of the first master piston NP is determined at a time point t5, by which the state of “hp 2 px” continues for a predetermined time tx, so as to eliminate impact of noise or the like. In detail, a duration Tx of the state is calculated from a time point at which “hP>px” is satisfied for the first time (a corresponding calculation cycle). Then, at the time point at which “Tx>tx” is satisfied, the bottoming state is determined. Here, the predetermined time tx is a threshold value corresponding to the duration Tx and is a predetermined value (a constant) that is set in advance. For example, the predetermined time tx can be set as the several calculation cycles.

At the bottoming determination time point t5, the determination flag FL indicating the bottoming state is switched from “0” to “1”. Here, in regard to the determination flag FL, “0” indicates that the bottoming state does not occur while “1” indicates that the bottoming state occurs. The determination flag FL is transmitted from the first controller ECA to the second controller ECB via the communication bus BS.

In the braking control device SC, the bottoming state of the first master piston NP (or the second master piston NS) is determined by comparing the servo pressure Pu to the front-wheel master pressure Pmf (or the rear-wheel master pressure Pmr). That is, the bottoming state is not determined by the comparison between the control target and the control result. For this reason, the bottoming determination is not affected by an error or a control delay in the pressure regulation control. The bottoming determination is based on a fact that, while the servo pressure Pu and the front-wheel master pressure Pmf (or the rear-wheel master pressure Pmr) match each other in the state where the first master piston NP (or the second master piston NS) does not bottom out, these no longer match each other once the first master piston NP (or the second master piston NS) bottoms out. Thus, the bottoming state of the first master piston NP (or the second master piston NS) can be determined promptly and reliably with the simple calculation processing.

The master pressure Pm is required to calculate the determination differential pressure hP, and the master pressure Pm is acquired from the general-purpose second pressure regulation unit YB via the communication bus BS. The second pressure regulation unit YB including the master pressure sensor PM is already provided to the braking control device SC in order to execute the vehicle stability control and the like. Thus, there is no need to newly provide the master pressure sensor PM to the braking control device SC for the bottoming determination. Also from this perspective, the bottoming state of the first master piston NP (or the second master piston NS) is determined with the simple configuration.

In the above description, the configuration of “ru=rm” is assumed. In a configuration that the servo area ru differs from the master area rm, the master pressure Pm is converted to correspond to the servo pressure Pu on the basis of the ratio between the pressure-receiving area ru of the servo chamber Ru and the pressure-receiving area rm of the master chamber Rm, and is then compared to the servo pressure Pu. More specifically, the master pressure Pm is converted to “Pm·rm/ru”, and the difference hP (the hydraulic pressure difference for the determination) between the servo pressure Pu and “Pm·rm/ru” is calculated. Then, in the case where the determination hydraulic pressure difference hP is equal to or greater than the predetermined pressure px (the constant that is set in advance), the bottoming state of the first master piston NP (or the second master piston NS) is determined.

Alternatively, the servo pressure Pu may be compared to the master pressure Pm in a dimension of the thrust force that acts on the first master piston NP (or the second master piston NS). More specifically, the thrust force (the servo thrust force) Fu related to the servo pressure Pu is calculated by “Pu·ru”, and the thrust force (the master thrust force) Fm related to the master pressure Pm is calculated by “Pm·rm”. Then, a difference hF (=Fu−Fm) between the servo thrust force Fu and the master thrust force Fm is calculated. In the case where the thrust force difference hF is equal to or larger than a predetermined force fx, the bottoming state is determined. Here, similar to the predetermined pressure px, the predetermined force fx is a threshold value for the bottoming determination and is a predetermined value (a constant) that is set in advance. In any case, the bottoming state of the first master piston NP (or the second master piston NS) is determined on the basis of the comparison between the servo pressure Pu and the master pressure Pm.

### <Operation in Compensation Control>

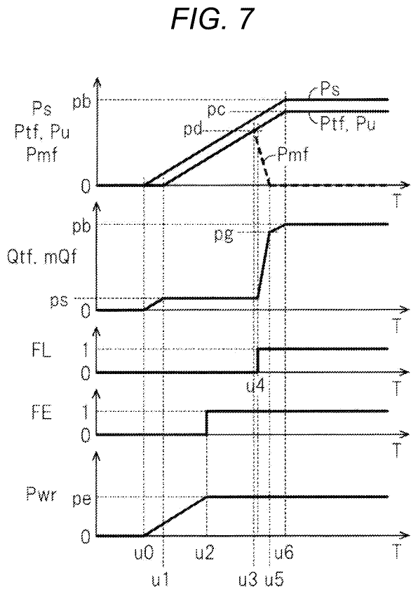

A description will be made on operation in the compensation control that is based on the bottoming determination result with reference to the time-series graphs in FIG. 7. The “compensation control” is executed to compensate for impact of the bottoming out (a reduction in the vehicle deceleration or the like) when the bottoming state is determined. In the example, the following matters are assumed.
At a time point u0, the operation of the braking operation member BP is started, and, from the time point u0 to a time point u1, the wheel pressure Pw is in the low hydraulic pressure region (the region where “Ps<ps”) and is pressurized only by the second pressure regulation unit YB. At the time point u1 onward, the wheel pressure Pw leaves the low hydraulic pressure region and thus is pressurized by both the first and second pressure regulation units YA, YB.
At a time point u2, the rear wheel pressure Pwr is limited by the braking force distribution control. At a time point u3, the bottoming state of the first master piston NP occurs, and, at a time point u4 immediately after this, the bottoming state of the first master piston NP is determined. At a time point u6, the braking operation member BP is held constant.
In the first fluid unit HA, the servo area ru and the master area rm are set to be equal.
The second pressure regulation unit YB does not employ the rear-wheel master pressure sensor PMr and is only provided with the front-wheel master pressure sensor PMf. Thus, the bottoming determination for the second master piston NS is not made.
The signal (the front-wheel master pressure) Pmf from the front-wheel master pressure sensor PMf is input to the second controller ECB and is transmitted to the first controller ECA via the communication bus BS. Then, the bottoming determination of the first master piston NP is made by the first controller ECA. Here, the front-wheel master pressure Pmf has a communication delay time with respect to the servo pressure Pu, which is not illustrated in FIG. 7.

At the time point u0, the operation of the braking operation member BP is started, and the braking operation amount Ba starts to increase. The required pressure Ps is increased in response to the increase in the braking operation amount Ba. Due to the low hydraulic pressure region in the initial braking period, the front-wheel target pressure Ptf remains “0”, and only the front-wheel target differential pressure Qtf is increased. The front-wheel actual differential pressure mQf (the actual value) is increased in response to the increase in the front-wheel target differential pressure Qtf (the target value). Since the front-wheel actual differential pressure mQf is controlled to approach and match the front-wheel target differential pressure Qtf, the graph of the front-wheel target differential pressure Qtf and the graph of the front-wheel actual differential pressure mof overlap each other.

At the time point u1, the front-wheel target differential pressure Qtf (resulting in the front-wheel actual differential pressure mQf) reaches the region determination pressure ps (the predetermined constant set in advance). From the time point u1, in addition to the front-wheel target differential pressure Qtf, the front-wheel target pressure Ptf is also increased. The servo pressure Pu (the actual value) is increased in response to the increase in the front-wheel target pressure Ptf (the target value). Since the servo pressure Pu is controlled to approach and match the front-wheel target pressure Ptf, the graph of the front-wheel target pressure Ptf and the graph of the servo pressure Pu overlap each other.

At the time point u2, the slip Slr of the rear wheel WHr (for example, a speed difference between the body speed Vx and the wheel speed Vwr) is increased, and execution of the braking force distribution control (the EBD control) is started. At the time point u2 onward, the required pressure Ps is increased. However, in order to suppress the increase in the rear-wheel slip Slr, an increase in the rear-wheel actual differential pressure wor (a difference between the rear-wheel regulated pressure Pqr and the rear wheel pressure Pwr) is limited by the rear-wheel inlet valve UIr. More specifically, the second target differential pressure Otr is calculated on the basis of the target rear wheel pressure Pvr, which is calculated on the basis of the rear-wheel slip Slr, and the front-wheel master pressure Pmf. Then, an energization amount (a current value) to the rear-wheel inlet valve UIr is controlled according to the second target differential pressure Otr. When the execution of the braking force distribution control is started, a control flag (an execution flag) FE indicating the execution thereof is switched from “0 (not executed)” to “1 (currently executed)”.

At the time point u3, the bottoming out of the first master piston NP occurs, and the front-wheel master pressure Pmf starts to reduce. At the time point u4 immediately after this, the front-wheel hydraulic pressure difference hPf (=Pu-Pmf) reaches the predetermined pressure px (the constant set in advance), and the bottoming state of the first master piston NP is determined. At the positive time point u4 for the bottoming determination (the processing in step S220), the determination flag (the control flag) FL indicating the bottoming state is switched from “0 (a non-occurring state)” to “1 (an occurring state)”.

At the same time, at the time point u4, the execution of the compensation control (the control for reducing the impact of the bottoming out) is started. More specifically, in the drive control for the pressure regulator UBf, the first front-wheel target differential pressure Qtf is calculated according to “Qtf=Ps-Ptf” until the time point u4. At the time point u4 onward, the front-wheel target differential pressure Qtf is calculated according to “Qtf=Ps−Pmf”. Here, the front-wheel target differential pressure Qtf is a target value that corresponds to the actual differential pressure mQf (the actual value) generated by the front-wheel pressure regulator UBf.

At the time point u3 onward, due to the bottoming out of the first master piston NP, the front-wheel master pressure Pmf becomes less likely to be generated, and the front wheel pressure Pwf becomes insufficient. However, at the time point u4, at which the bottoming state of the first master piston NP is determined, onward, the front-wheel master pressure Pmf is adopted in the calculation of the front-wheel target differential pressure Qtf, and the reduction thereof is reflected. As a result, the front-wheel master pressure Pmf by the first pressure regulation unit YA is reduced. However, the front-wheel target differential pressure Qtf is increased to compensate for this reduction. In this way, the front-wheel actual differential pressure mQf by the second pressure regulation unit YB is increased and compensates for the reduction in the front wheel pressure Pwf.

Furthermore, at the time point u4, as the compensation control, the control method for the rear-wheel inlet valve UIr in the braking force distribution control is changed. In the drive control for the rear-wheel inlet valve UIr, the second target differential pressure Otr is calculated according to “Otr=Pvr-Pmf” until the time point u4, but at the time point u4 onward, the second target differential pressure Otr is calculated according to “Otr=Pvr-Ptf”. Here, the second target differential pressure Otr is a target value that corresponds to an actual differential pressure mor (an actual value) generated by the rear-wheel inlet valve UIr. In addition, the target rear wheel pressure Pvr is the target value that corresponds to the rear wheel pressure Pwr (the actual value) in the braking force distribution control.

In the state where the first master piston NP does not bottom out, the front-wheel master pressure Pmf, which is detected by the front-wheel master pressure sensor PMf, is equal to the rear-wheel master pressure Pmr. Based on this, the rear-wheel master pressure sensor PMr is not provided, and the front-wheel master pressure Pmf is used in the drive control for the rear-wheel inlet valve UIr that is related to the braking force distribution control. On the other hand, when the first master piston NP bottoms out, the front-wheel master pressure Pmf no longer matches the rear-wheel master pressure Pmr. Accordingly, instead of the front-wheel master pressure Pmf, the front-wheel target pressure Ptf is adopted in the drive control for the rear-wheel inlet valve UIr. In the case where the front-wheel master pressure Pmf remains to be adopted even after the bottoming out of the first master piston NP, the rear wheel pressure Pwr is increased unnecessarily. However, based on the result of the bottoming determination, the calculation method for the rear-wheel target differential pressure Otr is changed. In this way, the increase in the rear wheel pressure Pwr is suppressed.

Hereinafter, the bottoming determination and the compensation control that is based on such a determination are summarized. Since the bottoming state of the first master piston NP is determined by the simple calculation processing on the basis of the comparison between the servo pressure Pu and the front-wheel master pressure Pmf, such a determination is made promptly and reliably. In addition, the calculation method for the front-wheel target differential pressure Qtf is changed on the basis of the result of the bottoming determination, and the reduction in the front-wheel master pressure Pmf in the first pressure regulation unit YA is compensated by the second pressure regulation unit YB. More specifically, in the second pressure regulation unit YB, in the case where the occurrence of the bottoming out of the first master piston NP is determined, the front-wheel target differential pressure Qtf is increased to be higher than that when the occurrence of the bottoming out of the first master piston NP is not determined. In this way, a degree (the actual differential pressure) mQf to increase the front-wheel master pressure Pmf (that is, the actual difference between the front-wheel master pressure Pmf and the front-wheel regulated pressure Pqf) is significantly regulated. Since the bottoming out of the first master piston NP is determined promptly, the front wheel pressure Pwf is increased immediately by the second pressure regulation unit YB.

Furthermore, the control method for the rear-wheel inlet valve UIr in the braking force distribution control is changed on the basis of the result of the bottoming determination of the first master piston NP. In this way, the differential pressures Otr (the target value), mor (the actual value) by the rear-wheel inlet valve UIr are controlled appropriately. That is, since the unnecessary increase in the rear wheel pressure Pwr is suppressed, vehicle stability is ensured. Similarly, since the bottoming out of the first master piston NP is determined in the short period of time from the occurrence thereof, disturbance of vehicle behavior can be avoided as much as possible.

The description has been made so far on the situation where the first master piston NP bottoms out. In the configuration where the rear-wheel master pressure sensor PMr is adopted, the bottoming state of the second master piston NS is determined on the basis of the comparison between the servo pressure Pu and the rear-wheel master pressure Pmr (for example, the rear-wheel determination differential pressure hPr). Furthermore, the calculation method for the rear-wheel target differential pressure Qtr is changed on the basis of the result of the bottoming determination on the second master piston NS, and the reduction in the rear-wheel master pressure Pmr in the first pressure regulation unit YA is compensated by the second pressure regulation unit YB. More specifically, in the second pressure regulation unit YB, in the case where the occurrence of the bottoming out of the second master piston NS is determined, the rear-wheel target differential pressure Qtr is increased to be higher than that when the occurrence of the bottoming out of the second master piston NS is not determined. In this way, a degree (the actual differential pressure) mQr to increase the rear-wheel master pressure Pmr (that is, the actual difference between the rear-wheel master pressure Pmr and Pqr) is significantly regulated. Similar to the above, since the bottoming out of the second master piston NS is determined promptly, the rear wheel pressure Pwr is increased immediately by the second pressure regulation unit YB.

### <Second Configuration Example of First Pressure Regulation Unit YA>

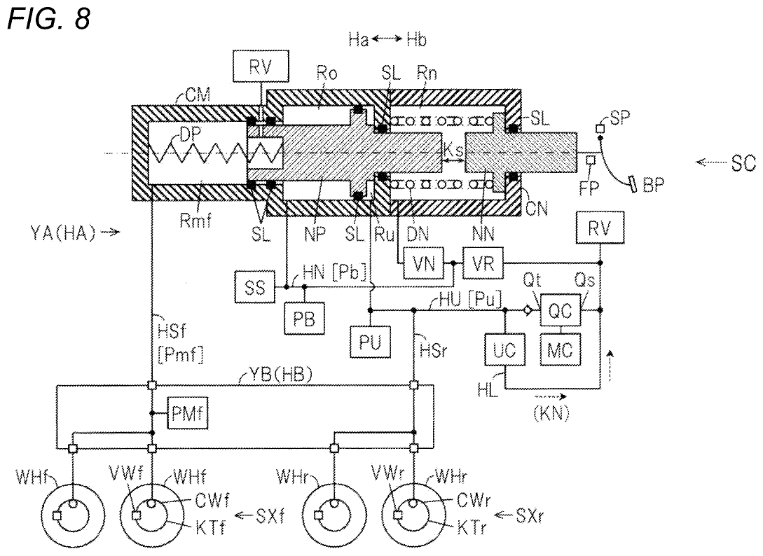

A description will be made on a second configuration example of the first pressure regulation unit (the upper pressure regulation unit) YA with reference to a schematic view in FIG. 8. In the first configuration example, the master cylinder CM of the tandem type with the two master chambers Rmf, Rmr is adopted. In the first pressure regulation unit YA, the first fluid unit HA of an accumulator type is adopted. More specifically, in the first fluid unit HA, the accumulator pressure Pc from the accumulator AC is used as the source pressure, the pilot pressure Pp is regulated by the pressure increase valve UZ and the pressure reduction valve UZ, and the servo pressure Pu is eventually regulated. Instead of the configuration of this accumulator type, in the second configuration example of the first pressure regulation unit YA (in particular, the first fluid unit HA), the master cylinder CM of a single type is adopted, and the servo pressure Pu is regulated by throttling the brake fluid discharged from a third fluid pump QC by a servo valve UC. Hereinafter, differences will mainly be described.

In the second configuration example of the first fluid unit HA, the rear-wheel master chamber Rmr is not provided. Thus, the rear-wheel master pressure sensor PMr is not adopted, and only the front-wheel master pressure sensor PMf that detects the front-wheel master pressure Pmf in the front-wheel master chamber Rmf is adopted. Similar to the second fluid unit HB, the servo pressure Pu is regulated when the brake fluid BF, which is discharged from the third fluid pump QC driven by a third electric motor MC, is throttled by the servo valve UC. More specifically, a suctioning section and a discharging section of the fluid pump QC are connected by the recirculation path HL (the fluid path) that is similar to the recirculation path HK. The recirculation path HL is provided with the servo valve UC (a similar solenoid valve to the pressure regulator UB) that is a normally-open linear valve. When the fluid pump QC is driven by the electric motor MC, the recirculation flow KN of the brake fluid is generated in the recirculation path HL. The servo pressure Pu is regulated by the orifice effect at the time when this recirculation flow KN is throttled by the servo valve UC. At the position between the discharging section of the fluid pump QC and the servo valve UC, the recirculation path HL is connected to the servo chamber Ru via a servo path HU. In this way, the servo pressure Pu is supplied to the servo chamber Ru. In addition, at the position between the discharging section of the fluid pump QC and the servo valve UC, the recirculation path HL is connected to the rear wheel cylinder CWr via the rear-wheel connection path HSr. In this way, the servo pressure Pu is directly supplied to the rear-wheel cylinder CWr.

Also, in the second configuration example, the bottoming state of the first master piston NP is determined promptly and reliably on the basis of the relationship between the servo pressure Pu and the front-wheel master pressure Pmf. Furthermore, in the case where the bottoming state of the first master piston NP is determined, the degrees (the differential pressures Qtf, mQf) to increase the front-wheel master pressure Pmf by the second pressure regulation unit YB are increased. Accordingly, the reduction in the front-wheel master pressure Pmf caused by the bottoming out can be compensated. That is, the same effect as that in the first configuration example described above is exerted.

### OTHER EMBODIMENTS

Hereinafter, a description will be made on other embodiments of the braking control device SC. Also, in other embodiments, similar effects to those described above (the prompt and reliable determinations on the bottoming states of the first and second master pistons NP, NS and the suppression of the bottoming impact by the compensation control that is based on the determination) are exerted.

In the above embodiment, in the service brake, the pressurization is performed only by the second pressure regulation unit YB when “Ps<ps”, and the pressurization is performed by both of the first and second pressure regulation units YA, YB when “Ps≥ps”. Instead of this, the pressurization in the service brake can always be performed by the first pressure regulation unit YA only. Also, in this configuration, the bottoming states of the first and second master pistons NP, NS are determined on the basis of the comparison between the servo pressure Pu and the master pressure Pm. Then, in the case where the bottoming states of the first and second master pistons NP, NS are determined, the degrees (that is, the differential pressures Qt, mQ) to increase the master pressure Pm by the second pressure regulation unit YB are increased, compared with the case where those are not determined. That is, when the bottoming state is not determined, the target differential pressure Qt (resulting the actual differential pressure mQ) is “0”. However, when the bottoming state is determined, the target differential pressure Qt (resulting the actual differential pressure mQ) is increased from “0” so as to compensate for the reduction in the master pressure Pm.

In the above embodiment, the master pressure Pm is acquired in the first controller ECA via the communication bus BS. Instead of this, the master pressure sensor PM may be connected to the first controller ECA, and the master pressure Pm may directly be acquired by the first controller ECA. However, since the second pressure regulation unit YB already includes the master pressure sensor PM as the general purpose unit, the entire configuration of the braking control device SC is simplified by acquiring the master pressure Pm from the second controller via the communication bus BS.

In the above embodiment, the configuration of the front-rear type is adopted as the two systems of brake fluid paths. Instead of this, a control system of a diagonal type (also referred to as an “X-type”) can be adopted. In such a configuration, of the two master chambers formed in the master cylinder CM, one is connected to the right front wheel cylinder and the left rear wheel cylinder, and the other is connected to the left front wheel cylinder and the right rear wheel cylinder. Also, in the configuration of the front-rear type, the bottoming state of the master piston is determined on the basis of the comparison between the hydraulic pressure Pm and the servo pressure Pu in the two master chambers.

In the above embodiment, the braking device SX of the disc brake type is adopted. Instead of this, the braking device SX of a drum brake type is adopted. In the braking device SX of the drum brake type, the rotary member KT is a brake drum, and the friction member MS is a brake lining provided to a brake shoe.

### <Summary of Embodiment of Braking Control Device SC>

Hereinafter, a description will be made on the summary of the embodiment of the braking control device SC.

The braking control device SC includes: the “master cylinder CM that has the master chamber Rm defined by the master pistons NP, NS”; and the “first pressure regulation unit YA that has the servo chamber Ru located on the opposite side of the master pistons NP, NS from the master chamber Rm, supplies the servo pressure Pu to the servo chamber Ru, and generates the master pressure Pm in the master chamber Rm”. In the first pressure regulating unit YA, the master pressure Pm and the servo pressure Pu are acquired. Then, the bottoming out of the master pistons NP, NS is determined on the basis of the comparison between the master pressure Pm and the servo pressure Pu. For example, in the first pressure regulation unit YA, the master pressure Pm and the servo pressure Pu are compared on the basis of the pressure-receiving area ru of the servo chamber Ru and the pressure-receiving area rm of the master chamber Rm. In addition, in the configuration that “ru=rm” is set, the occurrence of the bottoming out is determined by the first pressure regulation unit YA in the case where the difference hp (=Pu−Pm) between the servo pressure Pu and the master pressure Pm is equal to or greater than the predetermined pressure px.

In the braking control device SC, when the master bottoming does not occur, the servo pressure Pu and the master pressure Pm are in the predetermined relationship (for example, when “ru=rm” is set, the servo pressure Pu matches the master pressure Pm). However, this relationship is no longer established when the master bottoming occurs. Based on this, the bottoming state of the master piston is determined on the basis of the comparison between the servo pressure Pu and the master pressure Pm. That is, the bottoming determination is not made by the comparison between the control target and the control result. That is, the braking control device SC does not require a time required to avoid the impacts of the error in the pressure regulation control and the time delay in the pressure regulation control. Thus, in the braking control device SC, the reliable bottoming determination can be made in the short time by the simple calculation processing.

In the braking control device SC, the second pressure regulation unit YB capable of increasing and supplying the master pressure Pm to the wheel cylinder CW is provided between the master cylinder CM and the wheel cylinder CW. Then, in the case where the occurrence of the bottoming out is determined, in the second pressure regulation unit YB, the differential pressures Qt (the target pressure), mQ (the actual pressure) of the degrees to increase the master pressure Pm are increased compared with the case where the occurrence of the bottoming out is not determined.

In detail, when the master bottoming does not occur, the pressure regulator UB is controlled on the basis of “Qt=Ps-Pt”. However, when the master bottoming occurs, the pressure regulator UB performs the calculation on the basis of “Qt=Ps−Pm”. When the master bottoming occurs, the master pressure Pm is gradually reduced, and becomes 0 in the worst case. However, the calculation method is changed when the bottoming state is determined. Accordingly, the target differential pressure Qt is increased according to the reduction in the master pressure Pm. In this way, the degree (that is, the magnitude of the actual differential pressure mQ) to increase the master pressure Pm by the pressure regulator UB is increased, and impact of the master bottoming (the reduction in the vehicle deceleration, and the like) can be compensated.

1. A braking control device for a vehicle comprising:
a master cylinder that has a master chamber divided by a master piston; and
a first pressure regulation unit that has a servo chamber located on an opposite side of the master piston from the master chamber and supplies a servo pressure to the servo chamber, so as to generate a master pressure in the master chamber, wherein
the first pressure regulation unit
acquires the master pressure and the servo pressure, and
determines bottoming out of the master piston on the basis of a comparison between the master pressure and the servo pressure.

2. The braking control device for a vehicle according to claim 1, wherein
the first pressure regulation unit
makes the comparison on the basis of a pressure-receiving area of the servo chamber and a pressure-receiving area of the master chamber.

3. The braking control device for a vehicle according to claim 1, wherein
the first pressure regulation unit
determines occurrence of the bottoming out in the case where a difference between the servo pressure and the master pressure is equal to or greater than a predetermined pressure.

4. The braking control device for a vehicle according to claim 3 further comprising:
a second pressure regulation unit that is provided between the master cylinder and a wheel cylinder and can increase and supply the master pressure to the wheel cylinder, wherein
the second pressure regulation unit
increases a degree to increase a degree to increase the master pressure when the occurrence of the bottoming out is determined in comparison with a case where the occurrence of the bottoming out is not determined.

5. The braking control device for a vehicle according to claim 2 further comprising:
a second pressure regulation unit that is provided between the master cylinder and a wheel cylinder and can increase and supply the master pressure to the wheel cylinder, wherein
the second pressure regulation unit
increases a degree to increase a degree to increase the master pressure when the occurrence of the bottoming out is determined in comparison with a case where the occurrence of the bottoming out is not determined.

6. The braking control device for a vehicle according to claim 1 further comprising:
a second pressure regulation unit that is provided between the master cylinder and a wheel cylinder and can increase and supply the master pressure to the wheel cylinder, wherein
the second pressure regulation unit
increases a degree to increase a degree to increase the master pressure when the occurrence of the bottoming out is determined in comparison with a case where the occurrence of the bottoming out is not determined.
